(19) United States
(12) Patent Application Publication
(10) Pub. No.: US 2022/0330734 A1
(43) Pub. Date: Oct. 20, 2022

(54) Cup and method for the manufacturing of a cup

(71) Applicant: PACCOR Packaging GmbH, Dusseldorf (DE)

(72) Inventor: Slawomir Pryk, Skierniewice (PL)

(21) Appl. No.: 17/709,129

(22) Filed: Mar. 30, 2022

(30) Foreign Application Priority Data
Apr. 14, 2021 (DE) 20 2021 002 324.0
Apr. 14, 2021 (DE) 20 2021 002 771.8
Apr. 14, 2021 (EP) 21 168 361.0
Sep. 3, 2021 (EP) 21 194 862.5
Sep. 13, 2021 (EP) 21 196 300.4

(51) Int. Cl. A47G 19/22; B29C 51/00; B29C 51/08; B29C 51/26; B29C 59/00; B29C 59/02

(52) U.S. Cl. CPC A47G 19/2205; B29C 51/002; B29C 51/082; B29C 51/266; B29C 59/005; B29C 59/021; B29L 2031/7132

(57) ABSTRACT

A cup having a cup opening surrounded by a rim, a bottom opposite the cup opening, a longitudinal axis extending from the cup opening to the bottom, an upper portion disposed closer to the rim than to the bottom and having an outer surface and an inner surface, the upper portion either having a constant diameter or the upper portion being frustoconical and tapering from an upper diameter to a lower diameter, an intermediate portion disposed between the upper portion and the base, the intermediate portion having an outer surface and an inner surface, the intermediate portion either having a constant diameter or the intermediate portion being frustoconical and tapering from an upper diameter to a lower diameter, each diameter of the upper portion being greater than each diameter of the intermediate portion, wherein a sequence of characters is provided on the outer surface of the upper portion projecting above other portions of the outer surface.

The invention concerns a cup. Likewise, the invention relates to a method for manufacturing a cup.

Drinking cups made of polyethylene terephthalate (PET) by thermoforming according to the generic term of claim 1 are known from practice. Furthermore, it is known from practice that in these cups a calibration line is provided on the surface of the intermediate part, projecting over other parts of the outer surface. Furthermore, it is known from practice that on the outer surface of the intermediate part and adjacent to the calibration mark a sequence of characters, usually a volume indication such as “0.3” or “0.5”, projecting over other parts of the outer surface is provided.

Against this background, the invention was based on the task of providing a more detailed but still easily readable identification on the cup.

This task is solved by the object of claim 1 as well as by the method according to claim 11. Advantageous embodiments are set forth in the sub-claims and in the description that follows hereinafter.

The invention starts from the basic idea of creating the possibility,
that a sequence of characters is provided on the outer surface of the upper part projecting above other parts of the outer surface, and
that a transition is arranged between the upper part and the intermediate part.

In a preferred embodiment, the invention also provides, as part of the identification of the cup, a frame and even, in a preferred embodiment, pictograms disposed within the frame, and one, in a preferred embodiment, multiple sequences of characters as part of the identification. In a preferred embodiment, the invention provides, as part of the identification of the cup, no frame but at least one pictogram projecting from the outer surface of the top portion over other portions of the outer surface.

In contrast to the approaches known from the prior art, where markings of the cup are provided in the intermediate part, with this invention the possibility is created of making these nevertheless well readable despite the provided abundance of detail of the marking, because the sequence of characters provided according to the invention is provided in the upper part of the cup and in a preferred embodiment also the preferably provided frame is provided in the upper part of the cup. In particular, in a cup made by deep drawing, the material thickness of the cup wall decreases from the cup opening to the bottom. According to the findings of the invention, a sequence of characters, or a frame if provided, is more legible if it is produced in a portion of the cup that tends to be thick-walled (relative to other portions of the cup that are thinner-walled).

The cup has a cup opening surrounded by a rim. The rim can be formed as a radially outwardly projecting rim. Likewise, designs are conceivable in which the rim is formed by rolled-up material.

In a preferred embodiment, the cup aperture surrounded by the rim is circular.

The cup further comprises a bottom opposite the cup opening. The bottom can be flat. In a preferred embodiment, the bottom has a bead projecting into the interior of the cup. Complementary or alternative designs are possible in which the base comprises an outer standing ring having an annular, planar standing surface, the base further comprising an inner portion arranged inside the standing ring and recessed with respect to the standing surface of the standing ring. The return of the inner section of the bottom can be enabled by a stage. Likewise, the rebound of the inner portion of the bottom can be enabled by the bottom curving inward into the interior of the cup starting at the inner rim of the base. Likewise, a combination of a step and an inwardly curving inner section of the bottom is conceivable.

The base may have on its outer surface a sequence of characters projecting over other parts of the outer surface of the base, preferably a plurality of sequences of characters provided on the outer surface of the base and each projecting over other parts of the outer surface of the base. In addition or alternatively, a pictogram projecting above other portions of the outer surface of the bottom may be provided on the outer surface of the bottom. Preferably, a plurality of pictograms projecting from the outer surface of the bottom over other parts of the outer surface are provided.

In a preferred embodiment, the bottom has an outer circumference, which has a circular cross-section.

The cup according to the invention has a longitudinal axis extending from the cup opening to the bottom.

The cup has a cup wall extending from the rim to the bottom. The cup has a top part closer to the rim than to the bottom. In a preferred embodiment, the upper part immediately adjoins the rim. The upper part has an outer surface that is part of the outer surface of the cup wall. Furthermore, the upper portion has an inner surface that is part of the inner surface of the cup wall. The upper part can have a constant diameter. In an alternative embodiment, the upper portion is frustoconical in shape and tapers from an upper diameter to a lower diameter. The upper diameter is located closer to the rim than the lower diameter.

In a preferred embodiment, the constant diameter of the upper part, or the lower diameter of a frustoconical upper part is greater than 25 mm, preferably greater than 30 mm, preferably greater than 40 mm, preferably greater than 50 mm.

The cup has an intermediate part located between the upper part and the bottom. The intermediate portion has an outer surface, which forms part of the outer surface of the cup wall. The intermediate part has an inner surface, which forms part of the inner surface of the cup wall. The intermediate portion either has a constant diameter or the intermediate portion is frustoconical in shape and tapers from an upper diameter to a lower diameter, the upper diameter being located closer to the rim than the lower diameter.

Each diameter of the upper part is larger than each diameter of the intermediate part.

In a preferred embodiment, the constant diameter, or the lower diameter of the upper part is at least 1 mm, in particular preferably at least 2 mm, larger than the constant diameter of the intermediate part, or than the upper diameter of a frustoconical intermediate part.

A transition is arranged between the upper part and the intermediate part. The transition can be designed in the shape of a truncated cone. The transition may have an arcuate cross-section in a cross-section containing the longitudinal axis of the cup. The transition may be designed as a step. In a preferred embodiment, the length of the transition measured in the direction of the longitudinal axis is less than 15 mm, preferably less than 10 mm. In a preferred embodiment, the width of the step measured in the radial direction is greater than 0.2 mm, preferably greater than 0.5 mm, preferably greater than 1 mm, preferably greater than 2 mm. In a preferred embodiment, the width of the step measured in the radial direction is less than 15 mm, preferably less than 10 mm, preferably less than 7.5 mm, preferably less than 5 mm.

In a preferred embodiment, the length of the upper part measured in the direction of the longitudinal axis is smaller than the length of the intermediate part measured in the direction of the longitudinal axis. In a preferred embodiment, the ratio between the length of the intermediate part (LZ) measured in the direction of the longitudinal axis and the length of the upper part (LOT) LZ/LOT measured in the direction of the longitudinal axis is greater than 1.2, preferably greater than 1.5, preferably greater than 2, preferably greater than 2.5.

In a preferred embodiment, the length of the upper portion measured in the direction of the longitudinal axis is greater than 10 mm, preferably greater than 15 mm, preferably greater than 17 mm. In a preferred embodiment, the length of the upper part measured in the direction of the longitudinal axis is less than 35 mm, preferably less than 30 mm, preferably less than 17 mm.

In a preferred embodiment, a frame projecting above other portions of the outer surface is provided on the outer surface of the upper portion.

In a preferred embodiment, the frame has a rectangular shape, whereby both a rectangular shape with two opposing larger rims and two opposing shorter rims extending perpendicularly thereto is conceivable, and a square shape is conceivable. However, embodiments are also conceivable in which the frame is, for example, circular, elliptical or diamond-shaped or has the shape of a parallelogram.

In particular, the frame is preferably formed by a bead projecting over other portions of the outer surface. In a preferred embodiment, the bead has an apex line that has the shape of the frame. In a preferred embodiment, the apex line is rectangular, circular, elliptical, diamond-shaped, or parallelogram-shaped (depending on the shape of the frame formed by the bead).

In a preferred embodiment, the apex line is continuous. In a preferred embodiment, the apex line has the same distance (the same height) to a cylindrical reference surface (in the case of a cylindrical upper part) or to a frustoconical reference surface (in the case of a frustoconical upper part) over its entire extension.

Embodiments are conceivable in which the bead has indentations so that the apex line of the bead is interrupted. In a preferred embodiment, however, the apex line of the bead is a continuous, namely closed and unbroken line.

The frame has an upper, point or section located closer to the rim and a lower, point or section located closer to the bottom. In a preferred embodiment, the top point, or top section, is the portion of the frame located closest to the rim. In a preferred embodiment, the bottom point, or bottom section, is the point or section of the frame located closest to the ground.

In a frame designed as a rectangular frame, the upper portion of the frame is preferably a k ante of the rectangle, which is parallel to the rim. In the case of a frame designed as a rectangular frame, the lower portion is preferably an rim of the rectangle parallel to the rim.

For a frame designed as an ellipse, the top point may be e in vertex of the ellipse and the bottom point may be a vertex of the ellipse. In a diamond-shaped frame, the upper tip of the diamond-shaped frame may be the upper point of the frame and the lower tip of the diamond-shaped frame may be the lower point of the frame. In a preferred embodiment, a line connecting the upper point to the lower point extends in a plane that also contains the longitudinal axis of the cup.

In a preferred embodiment, in which the frame has a rectangular shape, upper portion is formed by an rim of the rectangle longer than an rim of the rectangle perpendicular to this rim. In a preferred embodiment, a rectangular frame thus extends in the circumferential direction of the upper part. In a preferred embodiment, the longer rims of the rectangle extend in the circumferential direction and the shorter rims of the rectangle extend in the direction from the rim to the ground.

In a preferred embodiment, the outer surface of the upper part is cylindrical or frustoconical over at least 30%, preferably over at least 50%, preferably over at least 75% of its extension and thus without beads or protrusions.

In a preferred embodiment, the reference area is understood to be the area containing the parts of the outer surface of the upper part which are cylindrical in shape when the upper part is cylindrical in shape and which has a constant diameter. In a preferred embodiment, the frustoconical surface is referred to as the reference surface, which includes the portions of the outer surface of the upper portion that are frustoconical when the upper portion is frustoconical, and which tapers from an upper diameter to a lower diameter.

In a preferred embodiment, the apex of the bead, which in a preferred embodiment forms the frame, is spaced u m at least 10 to 200 μm, preferably 10 to 50 μm, from the reference surface. The frame thus protrudes by at least 10 to 200 μm, preferably 10 to 50 μm, beyond the cylindrical or frustoconical parts of the outer surface of the upper part.

The frame extends in the circumferential direction of the upper part from a starting point or a starting portion to an end point or end portion offset in the circumferential direction from the starting point or starting portion. The starting point, or starting section, of the frame is preferably the point, or section, of the frame pointing furthest in the one circumferential direction (for example, the point, or section, of the frame pointing furthest in the clockwise direction). In the preferred embodiment, the end point or end section is the point or section of the frame which is arranged furthest in the opposite circumferential direction in relation to the starting point or starting section, i.e. in particular the point or section of the frame which is arranged furthest in the counterclockwise direction.

The starting section may be an rim of the frame, preferably the narrower rim of a frame, in the case of a frame of rectangular design. In the case of a rectangular frame, the end portion may in particular preferably be the opposite rim of the rectangle, preferably also a narrow rim of the rectangle. In an ellipse-shaped frame, the starting point may be a vertex of the ellipse and the ending point may also be a vertex of the ellipse. In a diamond-shaped frame, the starting point may be a tip of the diamond and the ending point may be the tip of a diamond.

In a preferred embodiment, the starting point and the end point lie on a circumferential line of the upper section, which runs in a plane perpendicular to the longitudinal axis.

According to the invention, the angle between a first radial of the upper part, which passes through the starting point or the starting section, and a second radial, which passes through the ending point or the ending section, is less than 90°, more preferably less than 80°, more preferably less than 75°, more preferably less than 70°, more preferably less than 50°. Thus, in the preferred embodiment, it is provided that the frame extends only over a limited surface portion of the upper part. In embodiments, in which the frame has a start portion and an end portion, the first radial and the second radial are disposed in a plane that is perpendicular to the longitudinal axis of the cup.

According to the invention, on the outer surface of the upper portion and adjacent to the frame, a sequence of characters is provided which projects above other portions of the outer surface. In a preferred embodiment, where a frame is provided on the outer surface of the top portion, the sequence of characters projecting above other portions of the outer surface is provided on the outer surface of the top portion and adjacent to the frame.

The sequence of characters preferably has at least three characters, preferably at least five characters, and more preferably at least 10 characters. In a preferred embodiment, the sequence of characters extends along a line. In a preferred embodiment, the line along which the sequence of characters extends in the circumferential direction. In a preferred embodiment, the sequence of characters consists mainly (more than 50%), in particular preferably mainly (more than 75%), of letters and, in a particularly preferred embodiment, entirely of letters and not of numbers . In a preferred embodiment, the sequence of characters has one, in particular preferably several, characters from a script for the blind, for example Braille. In a preferred embodiment, the sequence of characters consists mainly, in particular preferably entirely, of characters from a script for the blind, for example Braille.

In a preferred embodiment, the font used for the sequence of characters has a height greater than 4 points (4 pt), preferably equal to or greater than 5 points (5 pt). In a preferred embodiment, the font used for the sequence of characters has a height of less than 15 points (4 pt), preferably equal to or less than 10 points (5 pt).

In a preferred embodiment, the cup is made by deep drawing. The fact that the cup was manufactured by deep drawing can be recognized, for example, by the fact that the wall thickness of the cup wall in the area of the rim is thicker than the wall thickness of the cup wall in the area of the bottom.

In a preferred embodiment, the frame and/or sequence of characters is produced by a type of embossing. That the frame has been made by stamping can be seen in particular from the fact that on the inner surface of the upper part in each case the counterpart of the frame projecting on the outer surface with respect to other parts of the outer surface can be seen in the form of a frame receding with respect to other parts of the inner surface. That the sequence of characters has been produced by a kind of embossing can be seen in particular from the fact that on the inner surface of the upper part in each case the counterpart to the sequence of characters projecting on the outer surface relative to other parts of the outer surface can be seen in the form of a sequence of characters receding relative to other parts of the inner surface.

In the context of this description, embossing is understood to mean both a shaping process in which a specific shape is given to a material by means of an embossing die and a shaping process in which a shape is imprinted on a material that rests with one surface against a surface with recesses by applying excess pressure to the material at its free surface with a fluid, preferably compressed air, which presses the areas of the material that lie above the recesses into the recesses. For example, the recess has the shape of the frame to be created and/or the shape of the sequence of characters to be created.

In a preferred embodiment, the wall thickness of the upper part is constant and thicker than
the wall thickness of the intermediate part, for those embodiments in which the intermediate part also has a constant wall thickness, or
the thickest wall thickness of the intermediate part.

In a preferred embodiment, the thinnest wall thickness of the upper part is thicker than
the wall thickness of the intermediate part, for those embodiments in which the intermediate part also has a constant wall thickness, or
the thickest wall thickness of the intermediate part.

In a preferred embodiment, the wall thickness of the upper part is in the range of 75 to 900 μm, preferably 100 to 700 μm, preferably 150 to 600 μm, preferably 200 to 500 μm. The upper part can have a constant wall thickness. Preferably, the wall thickness of the upper part is thicker closer to the rim than further from the rim.

In one of the preferred embodiments, the wall thickness of the intermediate part is in a range 25 to 850 μm, preferably 50 to 700 μm, preferably 75 to 600 μm, preferably 100 to 500 μm. The intermediate part can have a constant wall thickness. Preferably, the wall thickness of the intermediate part is thicker closer to the upper part than further from the upper part.

In a preferred embodiment, the constant wall thickness of the upper part is thicker by a factor of 1.1, preferably by a factor of 1.17, preferably by a factor of 1.2, preferably by a factor of 1.4, preferably by a factor of 1.5 than
the wall thickness of the intermediate part, for those embodiments in which the intermediate part also has a constant wall thickness, or
the thickest wall thickness of the intermediate part.

In a preferred embodiment, the thinnest wall thickness of the upper part is thicker by a factor of 1.1, preferably by a factor of 1.17, preferably by a factor of 1.2 preferably by a factor of 1.4, preferably by a factor of 1.5 than
the wall thickness of the intermediate part, for those embodiments in which the intermediate part also has a constant wall thickness, or
the thickest wall thickness of the intermediate part.

In a preferred embodiment, a frame is provided on the inner surface of the upper part, which is preferably produced by embossing and is recessed with respect to other parts of the inner surface, the frame
has an upper point or section located closer to the rim and a lower point or section located closer to the bottom; and
as viewed in the circumferential direction of the upper part, has a start point or start portion and an end point or end portion offset in the circumferential direction from the start point or start portion, wherein the angle between a first radial of the upper part passing through the start point or start portion and a second radial passing through the end point or end portion is less than 90°.

In a preferred embodiment, the frame provided on the inner surface is provided at the location of the wall of the upper portion on the outer surface of which the frame projecting from the outer surface is provided. In a preferred embodiment, the frame provided on the inner surface and the frame projecting from the outer surface are produced in the same operation, preferably by embossing, for example by applying an internal pressure by means of a fluid, for example compressed air.

In a preferred embodiment, a sequence of characters is provided on the inner surface of the upper part and adjacent to the frame, preferably produced by embossing and recessed with respect to other parts of the inner surface.

In a preferred embodiment, the sequence of characters provided on the inner surface is provided at the location of the wall of the upper portion on the outer surface of which the sequence of characters projecting from the outer surface is provided. In a preferred embodiment, the sequence of characters provided on the inner surface and the sequence of characters projecting from the outer surface are produced in the same operation, preferably by embossing, for example by applying an internal pressure by means of a fluid, for example compressed air.

In a preferred embodiment, a lower portion is disposed between the intermediate portion and the base. The lower portion has an outer surface, which forms part of the outer surface of the cup wall. The lower portion further has an inner surface, which forms part of the inner surface of the cup wall. The lower part either has a constant diameter or the lower part is frustoconical in shape and tapers from an upper diameter, which is located closer to the rim, to a lower diameter, which is located closer to the bottom. Each diameter of the intermediate part is larger than each diameter of the lower part. In a preferred embodiment, several lower parts are provided underneath the intermediate part, whereby the one lower part arranged closer to the ground in each case is always smaller in diameter than a further lower part arranged further away from the ground and closer to the intermediate part. Transitions in the form of steps or frustoconical sections may be provided in each case between the various lower parts and between the intermediate part and the lower part disposed next to the intermediate part.

In a preferred embodiment, the cup is made of polyethylene terephthalate (PET). In a preferred embodiment, the PET has a recycled content. In a preferred embodiment, the recycled content is between 0% and 100%. In a preferred embodiment, the material of the cup is a single layer material. In another preferred embodiment, the material of the cup is a multilayer material. In a preferred embodiment, the material of the cup is a polypropylene (PP). In a preferred embodiment, the material of the cup is a polystyrene (PS). In a preferred embodiment, the material of the cup is a thermoformable material. In a preferred embodiment, the material of the cup is a homogeneous material. In a preferred embodiment, the material of the cup is a plastic based on renewable raw materials and/or a plastic that is biodegraded.

In a preferred embodiment, the material of the cup is transparent or opaque.

In a preferred embodiment, a pictogram projecting above other portions of the exterior surface is provided on the exterior surface of the upper portion. The pictogram is preferably created by embossing. In a preferred embodiment, at least one pictogram projecting above other portions of the exterior surface is provided on the exterior surface of the top portion and within the frame. The pictogram is preferably created by embossing. In a preferred embodiment, two pictograms are provided on the outer surface of the upper portion and within the frame, each projecting above other portions of the outer surface. The pictograms are preferably created by embossing.

In a preferred embodiment, an additional sequence of characters is provided on the outer surface of the top portion and within the frame, projecting above other portions of the outer surface. This sequence is in addition to the sequence of characters provided adjacent to the frame according to the invention.

In a preferred embodiment
a first sequence of characters, preferably produced by embossing, extending along a line, provided on the outer surface of the upper part and adjacent to the frame, and
a second, preferably embossed, sequence of characters extending along a line is provided on the outer surface of the upper part and adjacent to the frame.

In a preferred embodiment, at least two, preferably at least three, sequences of lettering, each extending along a line, are provided on a side of the frame adjacent to the frame. Preferably, the sequences of characters arranged on one side of the frame extend along lines that are parallel to each other.

In a preferred embodiment, at least two, preferably at least three, sequences of character strings, each extending along a line, are provided on one side of the frame adjacent the frame and at least two, preferably at least three, sequences of character strings, each extending along a line, are provided on the other side of the frame adjacent the frame. Preferably, the sequences of characters of this embodiment extend along lines that are parallel to each other. Preferably, at least one sequence of characters on one side of the frame extends along a line along which a sequence of characters on the other side of the frame also extends.

The respective line along which the respective sequence of characters extends in one of the preferred embodiments is preferably a circumferential line of the upper portion.

In a preferred embodiment, the cup has a volume of more than 0.1 liter, preferably more than 0.2 liter. In a preferred embodiment, the cup has a volume of less than 2 liters, preferably less than 1 liter, more preferably less than 0.75 liter.

The method of manufacturing a cup according to the invention provides that the cup is manufactured by thermoforming, and the frame and the sequence of characters are created by pressing on the inner surface of the upper part.

In a preferred embodiment, a thermoforming mold having a step is used for thermoforming the cup, wherein during thermoforming the upper part is formed above the step and the intermediate part is formed below the step. The heel can be used to create the transition between the upper part and the intermediate part. The step can be used to retain material above the step during preforming of the cup by means of a thermoforming die, so that the wall thickness of the upper part is significantly greater than the wall thickness of the intermediate part formed below the step.

In a preferred embodiment, the thermoforming mold has recesses on its inner surface. In this embodiment, the cup is preformed with a thermoforming die in the thermoforming mold, whereby a fluid, preferably compressed air with overpressure (for example 6 bar) is introduced into the preformed cup to form the frame and/or the sequence of characters and presses the material of the preformed cup into the recess.

In a preferred embodiment, a heated material web is clamped between a thermoforming die and a blank holder. In a preferred embodiment, a thermoforming die extends and preforms the cup in such a manner as to draw (press) material located above a recess of the thermoforming die into the recess of the thermoforming die. In a preferred embodiment, a fluid, preferably compressed air, is injected between the extended thermoforming die and the material surrounding it. This creates an internal pressure on the inner surface of the preformed cup, which presses the material of the preformed cup against the inner surface of the recess of the thermoforming mold. If recesses for forming a frame on the outer surface of the cup and/or recesses for forming a sequence of characters on the outer surface of the cup are provided in the inner surface of the recess of the thermoforming mold, the internal pressure presses the material into these recesses, thereby imprinting the cup with the frame and/or the sequence of characters on its outer surface.

In a preferred embodiment, the material is cooled before removal from the thermoforming mold.

In a preferred embodiment, the inner surface of the thermoforming mold is at least partially anodized, preferably at least in the areas of the recesses used to imprint the frame and/or sequence of characters.

In a preferred embodiment, the cup according to the invention is used as a drinking cup.

In the following, the invention is explained in more detail with reference to drawings which merely illustrate embodiments of the invention. Shown are:

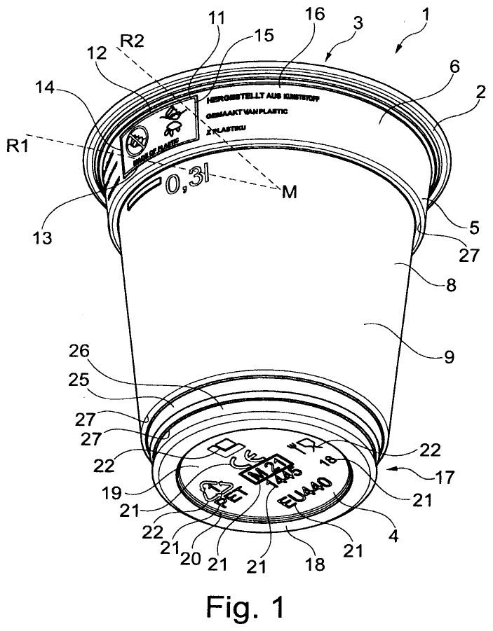

FIG. 1 a perspective view from below of a cup of an embodiment according to the invention with frame in the upper part;

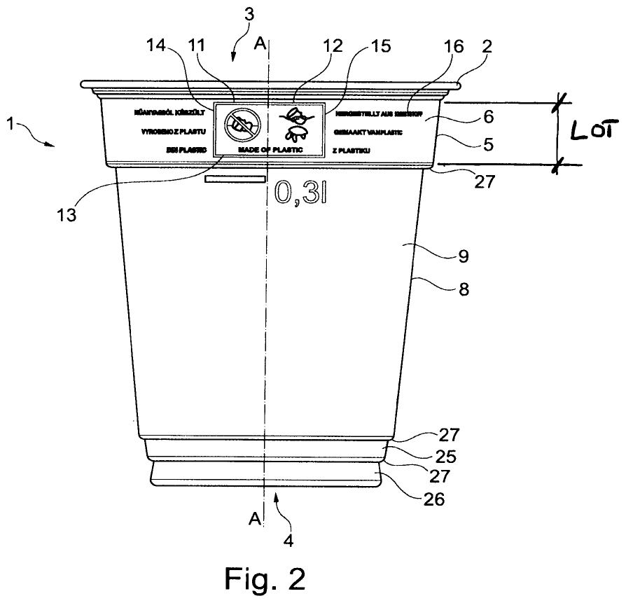

FIG. 2 a side view of the cup according to FIG. 1;

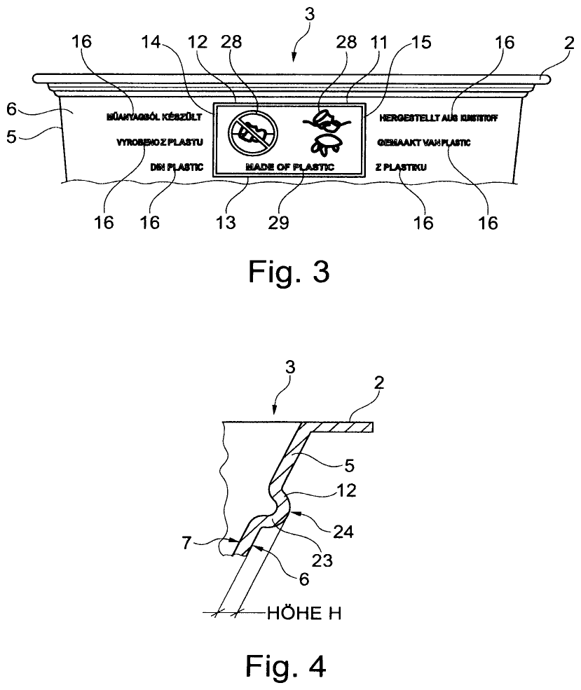

FIG. 3 an enlarged view of the rim and parts of the upper part of the cup according to FIG. 1;

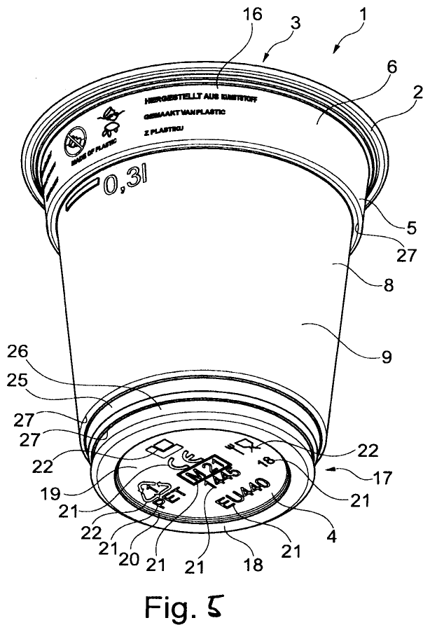

FIG. 4 a cutaway view of a detail of the cup of the invention, showing a section through the rim of the cup and the top portion of the frame;

FIG. 5 a perspective view from below of a cup of an embodiment according to the invention without a frame in the upper part;

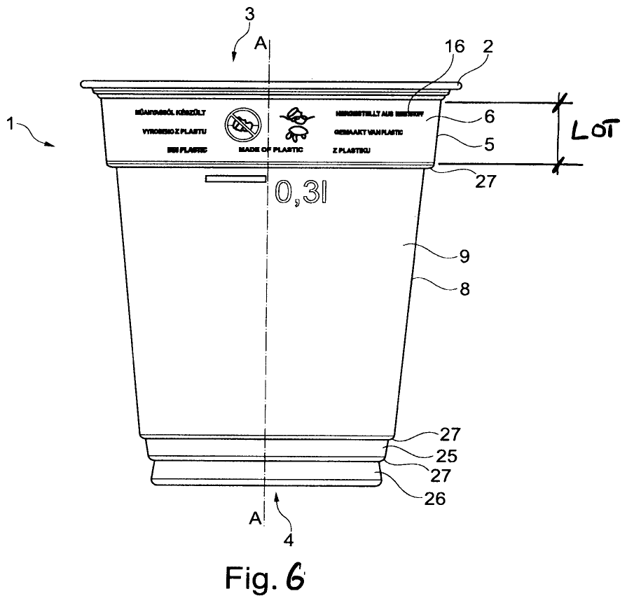

FIG. 6 a side view of the cup according to FIG. 5;

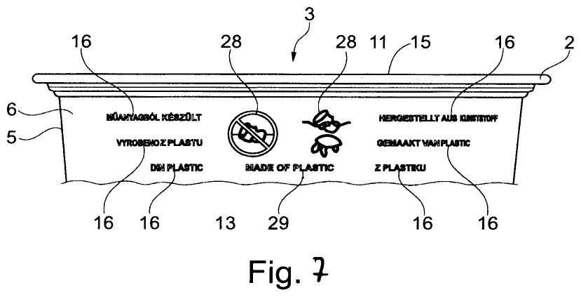

FIG. 7 an enlarged view of the rim and parts of the upper part of the cup according to FIG. 5;

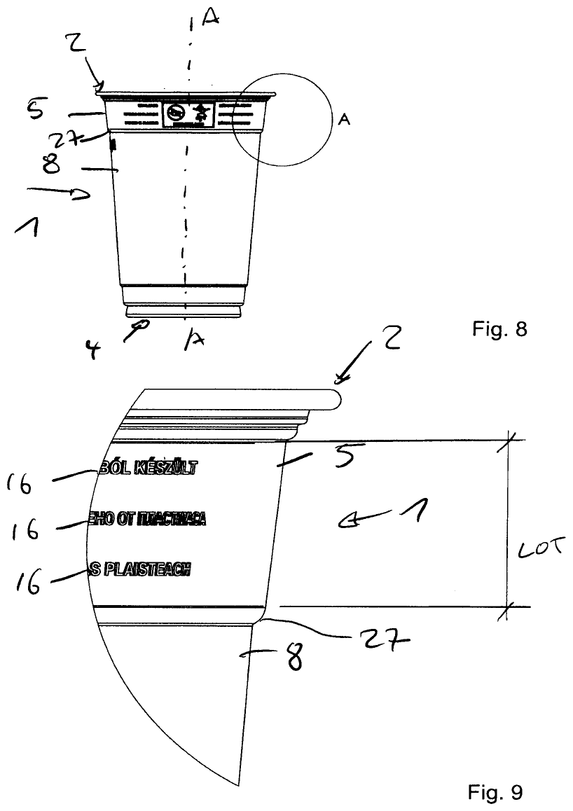

FIG. 8 a side view of a cup according to the invention with a detail A

FIG. 9 a side view of detail A of FIG. 8 in a magnified view, and

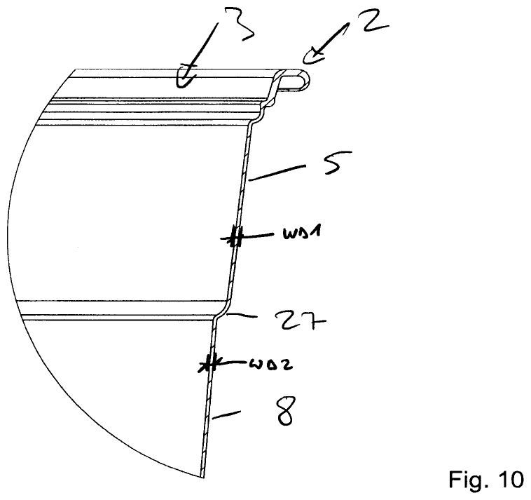

FIG. 10 a sectional view of the side view of detail A according to FIG. 9, also in enlarged view.

The cup 1 according to the invention has a cup opening 3 surrounded by a rim 2. A bottom 4 is provided opposite the cup opening 3. A longitudinal axis A runs from the cup opening 3 to the base 4.

The cup 1 has an upper portion 5 located closer to the rim 2 than to the base 4, which has an outer surface 6 and an inner surface 7. In the embodiment shown, the upper portion 5 is frustoconical in shape and tapers from an upper diameter to a lower diameter.

Between the upper part 5 and the bottom 4, an intermediate part 8 is executed, which has an outer surface 9 and an inner surface 10. In the embodiment shown, the intermediate portion 8 is frustoconical in shape and tapers from an upper diameter to a lower diameter.

Each diameter of the upper part 5 is larger than each diameter of the intermediate part 8. The length of the upper part LOT shown in FIG. 2, measured in the direction of the longitudinal axis, is between 10 mm and 30 mm, preferably between 15 and 25 mm.

On the outer surface 6 of the upper part 5, a frame 11 produced by embossing and projecting over other parts of the outer surface 6 is provided. In the embodiment shown, the frame 11 is rectangular. The frame has an upper section 12 located closer to the rim 2 and a lower section 13 located closer to the bottom 4. The frame, as viewed in the circumferential direction of the upper part, has a start portion 14 and an end portion 15 offset from the start portion 14 in the circumferential direction. The angle between a first radial R1 of the upper part passing through the start section 14 and a second radial R2 passing through the end section 15 is less than 90°. Radial R1 and radial R2 meet at a center point M, which lies on the longitudinal axis A, and run radially outward from there. Radial R1 and radial R2 lie in a plane that is perpendicular to longitudinal axis A.

On the outer surface 9 of the upper part 5 and adjacent to the frame 11 is provided a sequence 16 of characters produced by embossing and projecting above other parts of the outer surface. The font used for the sequence 16 of characters has a height of between 5 pt to 10 pt.

The cup opening 3 surrounded by the rim 2 is circular.

The base 4 has an outer standing ring 17, which has an annular, flat standing surface 18. The base 4 has an inner section 19 arranged inside the stand ring 17, which is recessed with respect to the standing surface 18 of the stand ring. For this purpose, a step 20 is provided and the inner section 19 is designed so that it curves inward starting at the step 20.

On its outer surface, the base 4 has a sequence 21 of characters and pictograms 22 produced by embossing and projecting above other parts of the outer surface of the base 4.

The base 4 has an outer circumference that has a circular cross-section.

The frame is formed by a bead 23 produced by embossing and projecting over other parts of the outer surface 6 (cf. FIG. 4). The bead 23 has an apex line 24, which has the shape of the frame. The apex of the bead, lying on the apex line 24, is spaced by a height H from the reference surface formed by the outer surface 6.

The wall thickness of the upper part 5 is in the range of 200 μm to 600 μm.

The embossing of the bead 23 can be accomplished by providing a recess in the inner surface of a thermoforming mold and by bringing the material of the cup 1 into contact with the inner surface 7 by applying an internal pressure, for example by means of compressed air, and pressing it into the recess in the inner surface of the thermoforming mold.

Two lower parts 25, 26 are arranged between the intermediate part 8 and the bottom 4. The lower portion 25 is frustoconical in shape and tapers from an upper diameter disposed closer to the rim 2 to a lower diameter disposed closer to the base 4. Each diameter of the intermediate part 8 is larger than each diameter of the lower part 25. Between the lower part 25 and the bottom 4 is the lower part 26. The lower portion 26 is frustoconical in shape and widens from an upper diameter disposed closer to the rim 2 to a lower diameter disposed closer to the base 4. Transitions 27, which are circular in cross-section, are provided between each of the various lower portions 25, 26 and between the intermediate portion 8 and the lower portion 25 disposed next to the intermediate portion 8. A transition 27 is also provided between the upper part 5 and the intermediate part 8, which is circular in cross-section.

The cup 1 is made of polyethylene terephthalate (PET) and is transparent.

Two embossed pictograms 28 and an embossed sequence 29 of characters are provided in the frame. The sequence 29 of characters extends along a line that is a circumferential line of the upper portion 5.

Three sequences 16 of characters are provided on each side of frame 1; thus, a total of six sequences 16 of characters are provided. Each sequence 16 of characters extends along a line that is a perimeter of the upper portion 5. The topmost sequence 16 of characters on the left side of frame 11 (FIG. 3) extends along the same perimeter as the topmost sequence 16 of characters on the right side of frame 11. The center sequence 16 of characters on the left side of frame 11 (FIG. 3) extends along the same perimeter as the center sequence 16 of characters on the right side of frame 11. The lowest sequence 16 of characters on the left side of frame 11 (FIG. 3) extends along the same perimeter as the lowest sequence 16 of characters on the right side of frame 11.

FIGS. 5 to 7 show that the advantages of the invention with regard to the legibility of the sequence 16 of characters and the pictograms can also be realized if no frame is provided in the upper part 5.

FIGS. 8 to 10 highlight that a transition 27 is provided between the upper part 5 and the intermediate part 8, which is circular in cross-section. In FIG. 10, “WD1” indicates the wall thickness of the upper part 5 and “WD2” indicates the wall thickness of the intermediate part 8. The wall thickness “WD1” is larger than the wall thickness “WD2”—even if this is only partially visible in the type of illustration in FIG. 10.

Advantageously, the transition 27 can be used to facilitate the adjustment of the wall thicknesses WD1 and WD2. If the material of the cup is held down in the area of the transition 27 during deep drawing with a first, outer punch and a correspondingly shaped mold, and if a second, inner punch is used to deep draw the sections of material used for the intermediate part 8, the outer punch in its interaction with a correspondingly shaped mold can reduce the amount of material that is drawn from the area of the upper part 5 into the area of the intermediate part 8 during deep drawing. As a result, the wall thickness WD1 of the upper part 5 remains thick, while the wall thickness of the intermediate part 8 becomes relatively thinner.

1.-13. (canceled)

14. A Cup comprising:
a rim defining a cup opening;
a bottom opposite the cup opening;
an upper part arranged closer to the rim than to the bottom, the upper part having an outer surface and an inner surface, wherein
the upper part either has a constant diameter, or the upper part is frustoconical in shape and tapers from an upper diameter to a lower diameter;
a longitudinal axis (A) running from the cup opening to the bottom;
an intermediate part arranged between the upper part and the bottom, the intermediate part having an outer surface and an inner surface, wherein
the intermediate portion either has a constant diameter or the intermediate portion is frustoconical in shape and tapers from an upper diameter to a lower diameter,
wherein each diameter of the upper part is larger than each diameter of the intermediate part;
wherein a sequence of characters is provided on the outer surface of the upper part and projects over other parts of the outer surface; and
wherein a transition is arranged between the upper part and the intermediate part.

15. The cup according to claim 14, further comprising a frame provided on the outer surface of the upper part and projecting over other parts of the outer surface, wherein
a. said frame has an upper point or section located closer to the rim and a lower point or section located closer to the bottom; and
b. as seen in the circumferential direction of the upper part, said frame has a starting point or starting section and an end point or end section offset in the circumferential direction from the starting point or starting section, wherein the angle between a first radial of the upper part passing through the starting point or starting section and a second radial passing through the end point or end section is less than 90°; and
c. wherein the sequence of characters projecting above other parts of the outer surface is provided on the outer surface of the upper part and adjacent to the frame.

16. The cup according to claim 14, said cup produced by deep drawing and the sequence of characters produced by embossing.

17. The cup according to claim 14, wherein a thinnest wall thickness of the upper part is equal to or thicker than a thickest wall thickness of the intermediate part.

18. The cup according to claim 14, further comprising a frame recessed with respect to other parts of the inner surface of the upper part and provided on the inner surface of the upper part, wherein
the frame has an upper point or section located closer to the rim, and a lower point or section located closer to the bottom; and
as seen in the circumferential direction of the upper part, the frame has a starting point or starting section and an end point or end section offset in the circumferential direction from the starting point or starting section, wherein the angle between a first radial of the upper part passing through the starting point or starting section and a second radial passing through the end point or end section is less than 90°;
and/or a sequence of characters is provided on the inner surface of the upper part and adjacent to the frame, and recessed with respect to other parts of the inner surface.

19. The cup according to claim 14, further comprising a lower portion disposed between the intermediate portion and the bottom and having an outer surface and an inner surface, wherein
the lower portion either has a constant diameter or the lower portion is frustoconical in shape and tapers from an upper diameter to a lower diameter; and
each diameter of the intermediate portion is greater than each diameter of the lower portion.

20. The cup according to claim 14, wherein the cup is made of polyethylene terephthalate.

21. The cup according to claim 15, wherein a pictogram projecting above other parts of the outer surface is provided on the outer surface of the upper part in the frame and/or a sequence of characters projecting above other parts of the outer surface is provided on the outer surface of the upper part in the frame.

22. The cup according to claim 15, further comprising:
a. a first sequence of characters extending along a line provided on the outer surface of the upper part and adjacent to the frame; and
b. a second sequence of characters extending along a line provided on the outer surface of the upper part and adjacent to the frame.

23. A method comprising:
deep drawing a cup comprising:
a rim defining a cup opening,
a bottom opposite the cup opening,
an upper part arranged closer to the rim than to the bottom, the upper part having an outer surface and an inner surface, wherein
the upper part either has a constant diameter, or the upper part is frustoconical in shape and tapers from an upper diameter to a lower diameter,
a longitudinal axis (A) running from the cup opening to the bottom;
an intermediate part arranged between the upper part and the bottom, the intermediate part having an outer surface and an inner surface, wherein
the intermediate portion either has a constant diameter or the intermediate portion is frustoconical in shape and tapers from an upper diameter to a lower diameter,
wherein each diameter of the upper part is larger than each diameter of the intermediate part; and
producing a sequence of characters by pressing on the inner surface of the upper part.

24. The method of claim 23, further comprising providing a frame projecting over other parts of the outer surface, wherein the frame and the sequence of characters is produced by pressing on the inner surface of the upper part.

25. The method according to claim 23, wherein said deep-drawing the cup further comprises using a deep-drawing mold having a step wherein during deep-drawing the upper part is formed above the step and the intermediate part is formed below the step.

26. The method according to claim 24, wherein the deep-drawing mold has recesses on its inner surface and the cup is preformed in the deep-drawing mold with a deep-drawing punch, and wherein the frame and/or the sequence of characters is formed by introducing a fluid into the preformed cup with overpressure and pressing the material of the preformed cup into the recess.
